(19) United States
(12) Patent Application Publication
(10) Pub. No.: US 2006/0008589 A1
(43) Pub. Date: Jan. 12, 2006

(54) Method of coating a photo-catalysis on a surface of a coated substrate

(76) Inventor: Li Lin, Taipei (TW)

Correspondence Address: NORTH AMERICA INTELLECTUAL PROPERTY CORPORATION, P.O. BOX 506, MERRIFIELD, VA, 22116, US

(21) Appl. No.: 10/884,997

(22) Filed: Jul. 7, 2004

(51) Int. Cl. B05D 5/00; B05D 3/00

(52) U.S. Cl. 427/421.1; 427/299

(57) ABSTRACT

A method of coating a photo-catalysis on a surface of a coated substrate, the method comprising the steps of: cleaning the surface of the coated substrate; measuring a temperature near the surface of the coated substrate; mixing for a water content of the colloid solution with TiO₂ by a water and the colloid solution with TiO₂ to form a mixture and pouring uniformly the mixture into a can of an airbrush; and spraying the colloid solution with the TiO₂on the surface of the coated substrate by a shape of micro-foam for decomposing the harmful substances in air as an anti-bacterial, a de-ordorization and an anti-mold function.

### BACKGROUND OF THE INVENTION

1. Field of The Invention

The present invention relates to a method of coating a photo-catalyst on a surface of a substrate to be coated, and especially to a method of coating a photo-catalyst on a surface of a substrate to be coated at a normal temperature.

2. Description of the Related

According to the demonstration of technology, a nano-meter TiO₂ has a good absorbency about ultraviolet rays and a high photocatalysis activity. When the nano-meter TiO₂ is illuminated by ultraviolet rays with a wavelength less than 388 nm, the nanometer TiO₂ particles produce large photoelectrons (e−) and photoholes (h+) on a conduction band and a valence band, respectively. The photoelectrons (e−) and photoholes (h+) respectively react with oxygen and water molecule to form a hydroxyl radical for decomposing an organic pollutant to form carbon dioxide (CO₂) and water, reducing a heavy-metal ion, and serve as a photocatalytical antibacterial.

According to the characteristic of the TiO₂, the material of TiO₂ can be used to clean an organic waste water and a fountainhead with like benzene, phenol, 12 alkyl benzene sulfonic acid sodium and monocrotophos, oxidize and decompose an organic chemical compound in a pipe network, and purge the water quality for health of human. Furthermore, the material of TiO₂ also can reduce a heavy-metal ion and adapt for photocatalysis antibacterial or increase the color on a ceramics and a glasses product.

Referring to FIG. 1, the prior art provide a method of coating a photo-catalyst on a surface of a substrate to be coated. The method comprises the steps of: cleaning dirt of the surface of the substrate to be coated by an alcohol or a cleanser, baking the surface of the substrate to be coated to form a dry and clean surface by a heat wind, pouring the colloid solution with 0.20%˜5% TiO₂ into a can of an airbrush, spraying the colloid solution with the TiO₂ on the surface of the substrate to be coated by a shape of micro-foam to form a photo-catalyst layer, wherein the mean diameter of the TiO₂ is about 7 nm, and baking the photo-catalyst layer by the hot wind above 500° C.

To sum up, the steps of the method comprises:
A. Cleaning the surface of the substrate to be coated;
B. Baking the surface of the substrate to be coated;
C. Spraying the colloid solution with the TiO₂ on the surface of the substrate to be coated by a shape of micro-foam to form a photo-catalyst layer; and
D. Baking the photo-catalyst layer by the hot wind above 500° C.

However, it has some defects according the method of prior art, including:

1. The content of the colloid solution with TiO₂ only has 0.20%˜5%, so a user must increase the spraying time to increase the TiO₂ content being coated on the substrate.

2. Baking the photo-catalyst layer by the hot wind above 500° C. is to increase one step for the method and not an applicable step to a heat-unresistant substrate.

3. Baking the photo-catalyst layer by the hot wind is to increase working equipments and working time, so that it also increases the cost.

With the employment of unique considerations and application of theories, and based on several years experience in specialized production of all flexible assembly systems and mechanisms, the inventor has come up with an innovative light-emitting diode chip package body.

### SUMMARY OF THE INVENTION

The first object of the present invention is to provide a method of coating a photo-catalyst on a surface. The colloid solution with the TiO₂ has an adhesive for adhering on any substrate without the step of baking. So that the method of the present invention is adapted to a low melting point substrate.

The second object of the present invention is to provide a method of coating a photo-catalyst on a surface of. The method does not bake the photo-catalyst layer, so that it will reduce the working time.

The third object of the present invention is to provide a method of coating a photo-catalyst on a surface. The method has more content of the colloid solution with TiO₂ for increasing the TiO₂ content on the substrate to be coated without increasing the spraying time.

In order to achieve the above objects, the present invention provides a method of coating a photo-catalyst on a surface. The method comprises the steps as follows. A surface is provided. The surface is cleaned. A temperature near the surface is measured. A colloid solution with TiO₂ is provided. Next, a water content of the colloid solution with TiO₂ is regulated according to the temperature by adding water to the colloid solution with TiO₂ to form a mixture. The mixture is poured into a can of an airbrush. Finally, the colloid solution with TiO₂ is sprayed on the surface in a shape of micro-foam.

In order to achieve the above objects, the present invention provides a method of coating a photo-catalyst on a surface. The method comprises the steps as follows. First, a surface is provided. A solution is formed by a cleanser and warm water and absorbed by an absorbing body for cleaning dirt of the surface. A temperature near the surface is measured. A colloid solution with TiO₂ is provided. Next, a water content of the colloid solution with TiO₂ is regulated according to the temperature by adding water to the colloid solution with TiO₂ to form a mixture. The mixture is poured into a can of an airbrush. Finally, the colloid solution the TiO₂ is sprayed on the surface away from 30 cm in a shape of micro-foam for fixing the colloid solution with TiO₂ on the surface.

In order to achieve the above objects, the present invention provides a method of coating a photo-catalyst on a surface, the method comprising the steps as follows. First, a surface is provided. A solution is formed by a cleanser and warm water and is absorbed by an absorbing body for cleaning dirt of the surface. A temperature near the surface is measured. A colloid solution with TiO₂ is provided. Next, a water content of the colloid solution with TiO₂ is regulated according to the temperature. The water content of the colloid solution with TiO₂, which includes TiO₂ as 30%, a fast-dry adhesive with acetone as 2˜3%, and water as the rest, (hereinafter also called “Solution”) based on the total weight of the Solution, is not changed when the temperature is under 25° C. But, when the temperature is between 25° C. to 30° C., the Solution should be added with more water which weight is equal to 5% of the Solution; when the temperature is between 30° C. to 40° C., the Solution should be added with more water which weight is equal to 10% of the Solution; when the temperature is over 40° C., the Solution should be added with more water which weight is equal to 15% of the Solution. The mentioned adding of water is for adjusting a solidified time of the fast-dry adhesive. The resulting colloid solution with TiO₂ is poured into a can of an airbrush. Finally, the colloid solution with TiO₂ is sprayed on the surface of the substrate away from 30 cm in a shape of micro-foam for fixing the colloid solution the TiO₂ on the surface.

It is to be understood that both the foregoing general description and the following detailed description are exemplary, and are intended to provide further explanation of the invention as claimed. Other advantages and features of the invention will be apparent from the following description, drawings and claims.

### BRIEF DESCRIPTION OF THE DRAWINGS

The various objects and advantages of the present invention will be more readily understood from the following detailed description when read in conjunction with the appended drawing, in which:

FIG. 1 is a flow chart illustrating of the method of coating a photo-catalyst on a surface of a substrate to be coated of the prior art;

FIG. 2 is a flow chart illustrating of the method of coating a photo-catalyst on a surface of a substrate to be coated of the present invention;

FIG. 3 is a schematic view of spraying the colloid solution with TiO₂ on the surface of the substrate to be coated in a shape of micro-foam according to the present invention; and

FIG. 3A is a schematic view of the micro-foam A, as shown in FIG. 3, of the present invention.

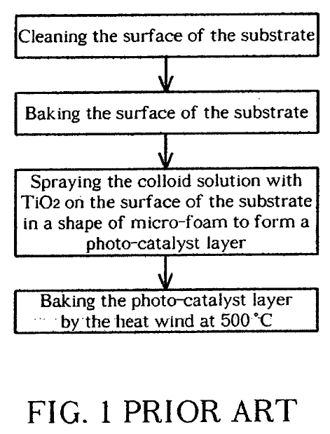

### DETAILED DESCRIPTION OF PREFERRED EMBODIMENTS

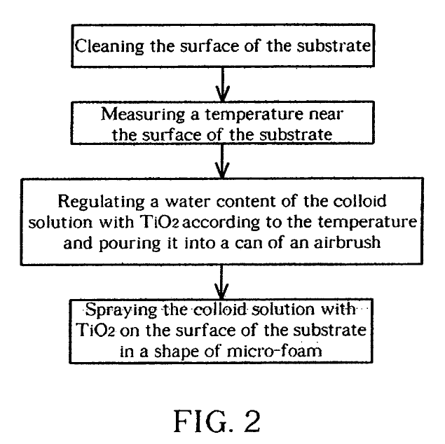

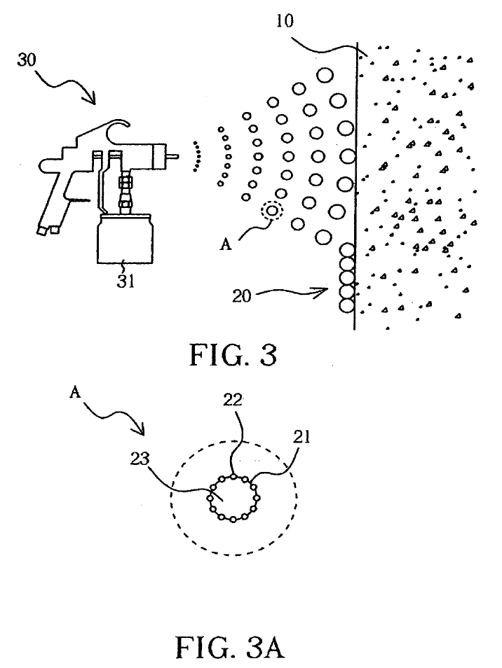

Referring to FIGS. 2 and 3, the present invention provides a method of coating a photo-catalyst on a surface of a substrate to be coated 10. The method comprises the steps of:

1. Cleaning the surface of the substrate to be coated 10, comprising forming a solution by a cleanser and warm water (about 60° C.) for increasing the cleaning velocity, and absorbing the solution by an absorbing body for cleaning dirt of the surface of the substrate to be coated 10;

2. Measuring a temperature near the surface of the substrate to be coated 10;

3. Regulating a water content of the colloid solution with TiO₂ by mixing a water and the colloid solution with TiO₂ to form a uniform mixture according to the temperature. The water content of the colloid solution with TiO₂, which includes TiO₂ as 30%, a fast-dry adhesive with acetone as 2˜3%, and water as the rest, based on the total weight of the colloid solution with TiO₂ (hereinafter called “Solution”), is not changed when the temperature is under 25° C. But, when the temperature is between 25° C. to 30° C., the Solution should be added with more water which weight is equal to 5% of the Solution; when the temperature is between 30° C. to 40° C., the Solution should be added with more water which weight is equal to 10% of the Solution; when the temperature is over 40° C., the Solution should be added with more water which weight is equal to 15% of the Solution. The mentioned adding of water is for adjusting a solidified time of the fast-dry adhesive. The resulting colloid solution with TiO₂ is poured into a can 31 of an airbrush 30; and

4. Spraying the colloid solution with TiO₂ on the surface of the substrate to be coated 10 away from 30 cm in a shape of micro-foam for fixing the colloid solution with TiO₂ on the surface of the substrate to be coated 10, wherein the colloid solution with TiO₂ has a plurality of particles 22 attached on an external wall 21 of the micro-foam thereof. When the micro-foam sprays on the coated substrate, the colloid solution with TiO₂ can contact enough with an external world for developing the photo-catalytic efficiency of the colloid solution with TiO₂.

Referring to FIG. 3A, the colloid solution with TiO₂ includes TiO₂ as 30%, a fast-dry adhesive with acetone as 2˜3%, and water as the rest, based on the total weight of the colloid solution with TiO₂.

The adhesive has a polyethylene to form an external wall 21. The colloid solution with TiO₂ has a plurality of particles 22 attached on the external wall 21 of the micro-foam thereof, and the micro-foam covers the air, so that the colloid solution with TiO₂ can contact enough with an external world for developing the efficiency of the colloid solution with TiO₂.

The adhesive is fast-dry type, so that the colloid solution with TiO₂ adheres on the substrate to be coated 10 fast. The TiO₂ particles 22 of the colloid solution with TiO₂ is relatively small, such that the content of TiO₂ particles in a micro-foam is relatively large. Therefore, it is enough for the step of spraying the colloid solution with TiO₂ on the surface of the substrate to be coated 10 to be only proceeded one time. Wherein the step of regulating a water content of the colloid solution with TiO₂ by mixing a water and the colloid solution with TiO₂ allows the sprayer sprays the colloid solution with the TiO₂ on the surface of the substrate to be coated away from about 30 cm, without a need to adjust the spraying distance or a pressure of the sprayer depending on a higher or lower temperature near the surface to be coated.

To sum up, the present invention has some advantages comprising:

1. The method does not need the baking step, so that the substrate to be coated can be any material;

2. The method does not need the baking step, so that it will reduce the working time;

3. The colloid solution with TiO₂ has a plurality of TiO₂ particles attached on an external wall of the micro-foam thereof. When the micro-foam is sprayed on the substrate to be coated, the TiO₂ particles can contact enough with an external world for developing the photo-catalytic efficiency of the colloid solution with TiO₂; and

4. The method only needs one time to spray the colloid solution with TiO₂ on the surface of the substrate to be coated for reducing the working time.

Although the present invention has been described with reference to the preferred embodiment thereof, it will be understood that the invention is not limited to the details thereof. Various substitutions and modification have suggested in the foregoing description, and other will occur to those of ordinary skill in the art. Therefore, all such substitutions and modifications are intended to be embraced within the scope of the invention as defined in the appended claims.

1. A method of coating a photo-catalyst on a surface comprising the steps of:
providing a surface;
cleaning the surface;
measuring a temperature near the surface;
providing a colloid solution with TiO₂;
regulating a water content of the colloid solution with TiO₂ according to the temperature by adding water to the colloid solution with TiO₂ to form a mixture;
pouring the mixture into a can of an airbrush; and
spraying the colloid solution with TiO₂ on the surface in a shape of micro-foam.

2. The method as claimed in claim 1, wherein the step of cleaning the surface includes forming a solution of a cleanser and water at 60° C., absorbing the solution with an absorbing body, and cleaning the surface by the absorbing body with the solution.

3. The method as claimed in claim 1, wherein the colloid solution with TiO₂ includes, based on the total weight of the colloid solution with TiO₂, 30% by weight of TiO₂, 2 to 3% by weight of a fast-dry adhesive with acetone, and water as the rest.

4. The method as claimed in claim 3, wherein the fast-dry adhesive comprises a polyethylene.

5. The method as claimed in claim 1, wherein the TiO₂ has a mean diameter about 2 nm.

6. The method as claimed in claim 1, wherein, regulating a water content of the colloid solution with TiO₂ according to the temperature is performed by:
not adding water to the colloid solution with TiO₂ at the temperature under 25° C.;
adding 5% by weight of water to the colloid solution with TiO₂ at the temrerature between 25° C. and 30° C.;
adding 10% by weight of water to the colloid solution with TiO₂ at the temperature between 30° C. and 40° C.; or
adding 15% by weight of water to the colloid solution with TiO₂ at the ternmpature over 40° C.; TiO₂.

7. The method as claimed in claim 1, wherein the step of spraying the colloid solution with the TiO₂ includes spraying the colloid solution with the TiO₂ on the surface away from the surface by about 30 cm.

8. A method of coating a photo-catalyst on a surface, comprising the steps of:
providing a surface;
forming a solution by a cleanser and warm water;
absorbing the solution with an absorbing body for cleaning dirt of the surface;
measuring a temperature near the surface;
providing a colloid solution with TiO₂;
regulating a water content of the colloid solution with TiO₂ according to the temperature by adding water to the colloid solution with TiO₂ to form a mixture;
pouring the mixture into a can of an airbrush; and
spraying the colloid solution with TiO₂ on the surface away from 30 cm in a shape of micro-foam for fixing the colloid solution with the TiO₂ on the surface.

9. The method as claimed in claim 8, wherein the temperature of the warm water is about 60° C.

10. The method as claimed in claim 8, wherein the colloid solution with TiO₂ includes, based on the total weight of the colloid solution with TiO₂, 30% by weight of TiO₂, 2 to 3% by weight of a fast-dry adhesive with acetone, and water as the rest.

11. The method as claimed in claim 10, wherein the adhesive comprises a polyethylene.

12. The method as claimed in claim 8, wherein the TiO₂ has a mean diameter about 2 nm.

13. The method as claimed in claim 8, wherein regulating a water content of the colloid solution with TiO₂ according to the temperature is performed by:
not adding water to the colloid solution with TiO₂ at the temperature under 25° C.;
adding 5% by weigzht of water to the colloid solution with TiO₂ at the temperature between 25° C. and 30° C.;
adding 10% by weight of water to the colloid solution with TiO₂ at the temperature between 30° C. and 40° C.; or
adding 15% by weight of water to the colloid solution wig TiO₂ at the temperature over 40° C.;
wherein the weight percent is based on the total weight of the colloid solution with TiO₂.

14. The method as claimed in claim 8, wherein the colloid solution with TiO₂ in a shape of micro-foam is formed to have a plurality of TiO₂ particles attached on an external wall of the micro-foam for contacting with an external world.

15. A method of coating a photo-catalyst on a surface, the method comprising the steps of:
providing a surface;
forming a solution by a cleanser and warm water, and absorbing the solution by an absorbing body for cleaning dirt of the surface;
measuring a temperature near the surface;
providing a colloid solution with TiO₂ including, based on the total weight of the colloid solution with TiO₂, 30% by weight of TiO₂, 2 to 3% by weight of a fast-dry adhesive with acetone, and water as the rest;
regulating a water content of the colloid solution with TiO₂ according to the temperature by adding water to the colloid solution with TiO₂ to form a mixture, wherein, regulating a water content of the colloid solution with TiO₂ according to the temperature is performed by;
not adding water to the colloid solution with TiO₂ at the temperature under 25° C.;
adding 5% by weight of water to the colloid solution with TiO₂ at the temperature between 25° C. and 30° C.;
adding 10% by weight of water to the colloid solution with TiO₂ at the temperature between 30° C. and 40° C.; or
adding 15% by weight of water to the colloid solution with TiO₂ at the temperature over 40° C.;
wherein the weight percent is based on the total weight of the colloid solution with TiO₂;
pouring the mixture into a can of an airbrush; and
spraying the colloid solution with TiO₂ on the surface away from 30 cm in a shape of micro-foam for fixing the colloid solution with the TiO₂ on the surface.

16. The method as claimed in claim 15, wherein the temperature of the warm water is about 60° C.

17. The method as claimed in claim 15, wherein the adhesive comprises a polyethylene.

18. The method as claimed in claim 15, wherein the colloid solution with TiO₂ in a shape of micro-foam is formed to have a plurality of TiO₂ particles attached on an external wall of the micro-foam for contacting with an external world.
